(19) United States
(12) Patent Application Publication
(10) Pub. No.: US 2006/0060227 A1
(43) Pub. Date: Mar. 23, 2006

(54) Dishwasher

(75) Inventors: Dae Yeong Han, Seoul (KR); Sang Heon Yoon, Seoul (KR); Nung Seo Park, Incheon (KR); Hyeok Deok Kim, Changwon-si (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/094,500

(22) Filed: Mar. 31, 2005

(30) Foreign Application Priority Data
Sep. 22, 2004 (KR) P2004-75849

(51) Int. Cl. B08B 3/00; B08B 3/04

(52) U.S. Cl. 134/56 D; 134/104.2

(57) ABSTRACT

Provided is a dishwasher having an improved structure. The dishwasher includes a sump for collecting washing water for washing a contaminated dish, and a main motor for circulating the washing water collected in the sump. Furthermore, the dishwasher includes a washing pump having an impeller connected with the main motor to pump the washing water, and a discharge pump disposed at a predetermined portion of the sump for discharging the washing water. Also in the dishwasher, a lower housing having a contaminant chamber is disposed on a substantially same plane as the impeller for filtering some of the washing water. According to the present invention, the dishwasher can increase the dishwashing space and discharge contaminant in an inside of the dishwasher with ease.

This application claims the benefit of Korean Application No. P2004-0075849 filed on Sep. 22, 2004, which is hereby incorporated by reference as if fully set forth herein.

### BACKGROUND OF THE INVENTION

1. Field of the Invention

The present invention relates to a dishwasher, and more particularly, to a dishwasher that can increase a space for washing a dish and discharge waste with ease.

2. Discussion of the Related Art

In general, a washing machine is a machine that automatically washes dishes, enabling a user to reduce domestic chores since it provides various functions such as washing, rinsing, drying, and holding the dishes.

The washing machine can be classified into shower type dishwashers and ultrasonic dishwashers based on their washing methods. The shower type dishwashers, which are mainly used in homes, wash dishes received in a dish container by spraying warm water mixed with detergent onto the dishes.

Here, water may be sprayed using either a propeller or a pipe having a plurality of holes. A related art dishwasher will now be described with reference to FIG. 1.

The dishwasher includes a tub 1 for providing a dishwashing space, upper and lower spray arms 4 and 5 rotatably installed inside the tub 1, upper and lower racks 6 and 7 mounted on the upper and lower spray arms 4 and 5, and a driving part 10 for driving the dishwasher.

Upper and lower connection pipes 2 and 3 for pumping washing water and a discharge hose 9 for discharging washing water are connected to the driving part 10. The upper and lower spray arms 4 and 5 are connected to the upper and lower connection pipes 2 and 3. The upper rack 6 is mounted above the upper spray arm 4 and the lower rack 7 is mounted above the lower spray arm 5.

Each of the upper and lower spray arms 4 and 5 has a plurality of spray holes for spraying the washing water upward. The lower spray arm 5 has a separate spray hole for scraping food waste filtered by a filter of the driving part 10.

Operations of the related art dishwasher will now be described.

To perform dishwashing, a user puts dishes to be washed on the upper and lower racks 6 and 7 and then inputs a desired operation cycle. Then a predetermined amount of washing water is filled in the driving part 10 of the dishwasher through a feed valve connected with an exterior of the dishwasher.

After that, a heater heats the washing water. Then, as a motor operates to drive a washing pump, heated washing water is transferred to the upper and lower spray arms 4 and 5 through the upper and lower connection pipes 2 and 3. The washing water that is introduced the upper and lower spray arms 4 and 5 is sprayed through the spray holes to remove garbage attached on a surface of the dishes.

After the dishwashing is completed, the garbage separated from the surface of the dishes and waste washing water are again collected in a sump of the driving part. At this time, when pollution of the waste washing water is above a predetermined level, the dishwasher discharges the waste washing water mixed with garbage and is then supplied with clean water.

Meanwhile, when the pollution of the waster washing water is below the predetermined level, the dishwasher filters the water collected in the sump of the driving part and transfers the filtered water to the upper and lower spray arms 4 and 5. Thereafter, when the dishwashing is completed, the washing water collected in the sump of the driving part is discharged together with the garbage to an outside via a discharge pump.

However, the related art dishwasher has the following drawbacks. First, since the driving part is leveled at a relatively high position, it is problematic that the dishwashing space is decreased. Second, since a bottom surface of a contaminant chamber installed in the driving part of the dishwasher is plane, it is problematic that the garbage collected in the contaminant chamber is not completely discharged. Lastly, since a large volume of garbage is introduced into the contaminant chamber installed in the driving part of the dishwasher, it is problematic that the filter disposed at an upper side of the contaminant chamber clogs with the garbage.

### SUMMARY OF THE INVENTION

Accordingly, the present invention is directed to a dishwasher that substantially obviates one or more problems due to limitations and disadvantages of the related art.

An object of the present invention is to provide a dishwasher that can increase a space for washing a dish.

Another object of the present invention is to provide a dishwasher that can discharge garbage collected in a contaminant chamber of the dishwasher with ease.

A further another object of the present invention is to provide a dishwasher that can prevent a large volume of garbage from being introduced into a contaminant chamber of the dishwasher.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a dishwasher. The dishwasher includes a sump for collecting washing water for washing a contaminated dish, and a main motor for circulating the washing water collected in the sump. Furthermore, the dishwasher includes a washing pump having an impeller connected with the main motor to pump the washing water, and a discharge pump disposed at a predetermined portion of the sump for discharging the washing water. The dishwasher further includes a lower housing having a contaminant chamber disposed on a substantially same plane as the impeller for filtering some of the washing water.

Preferably, the lower housing comprises an impeller receiving part for receiving a lower portion of the impeller.

Preferably, the impeller receiving part comprises an inlet flow passage, and through which the washing water collected in the sump is introduced, formed around the receiving part, the inlet flow passage has a height different with the impeller receiving part.

Preferably, the above dishwasher further includes an upper housing having an impeller cap for receiving an upper side of the impeller.

Preferably, the upper housing comprises a sampling flow passage connecting the inlet flow passage with the discharge pump.

Preferably, the washing water introduced into the inlet flow passage during a washing cycle is introduced into the contaminant chamber sequentially via the sampling flow passage and the discharge pump.

Preferably, an upper housing installation part on which the upper housing is installed is formed around the inlet flow passage with a predetermined height difference from the inlet flow passage.

Preferably, the contaminant chamber is formed around the upper housing installation part with a predetermined depth, and the impeller receiving part and the contaminant chamber are formed in as an integrated member.

In detail, the contaminant chamber has an angled bottom surface declining in a direction of the discharge pump.

Preferably, the dishwasher further includes a cover having a filtering part for filtering the washing water introduced into the contaminant chamber.

Preferably, the cover is installed at an upper side of the upper housing and the lower housing.

Preferably, the lower housing comprises a contaminant chamber having a bottom surface declining at a predetermined angle in a direction of a discharge chamber.

Another aspect of the present invention, there is provided a dishwasher comprising a sump for collecting washing water for washing a contaminated dish, a main motor for circulating the washing water collected in the sump, a washing pump having an impeller connected with the main motor to pump the washing water, a discharge pump disposed at a predetermined portion of the sump for discharging the washing water, and a contaminant chamber into which the washing water pumped by the impeller is continuously introduced and has an angled bottom surface declining at a predetermined angle.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view illustrating an inner construction of a related art dishwasher;

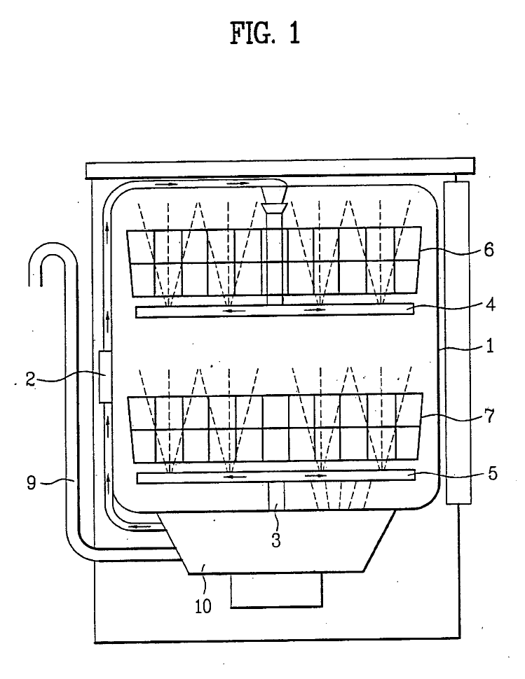

FIG. 2 is a block diagram illustrating an inner construction of a dishwasher according to an embodiment of the present invention;

FIG. 3 is an exploded perspective view of a main part of FIG. 2;

FIG. 4 is a perspective view illustrating a coupling relationship among the sump, upper housing and lower housing shown in FIG. 3;

FIG. 5 is a sectional view taken along the like II-II of FIG. 4;

FIG. 6 is a detailed perspective view of a portion ‘A’ of FIG. 4;

FIG. 7 is a perspective view illustrating a flow of washing water as being fed to an upper spray arm of a dishwasher according to the present invention; and

FIG. 8 is a perspective view illustrating a flow of washing water in a discharge cycle of a dishwasher according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

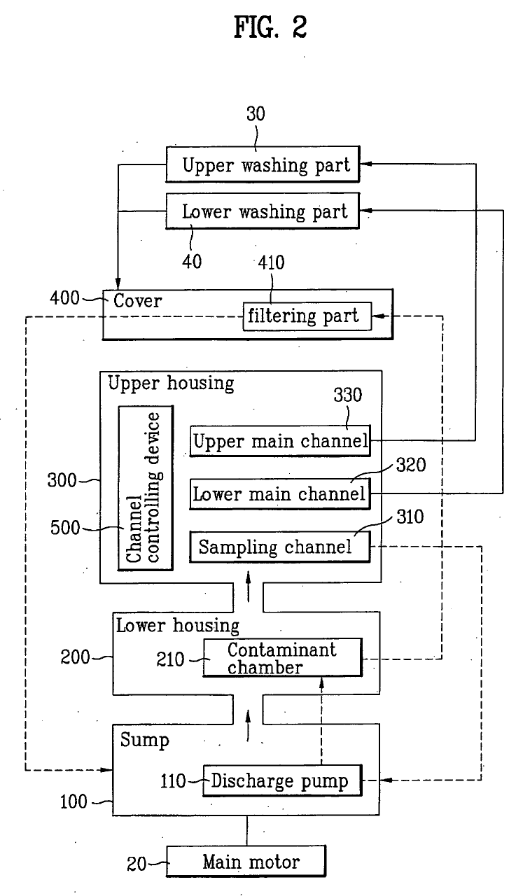

A flow passage of washing water of a dishwasher according to the present invention will now be described with reference to FIG. 2.

Referring to FIG. 2, a sump 100 containing washing water therein is disposed at a lower side of the dishwasher, and a lower housing 200 defining a contaminant chamber 210 is disposed inside the sump 100. Additionally, an upper housing 300 is disposed inside the sump 100 to define a flow passage of washing water. A cover 400 covering the upper housing 300 is disposed at an upper surface of the upper housing 300.

First, the washing water contained in the sump 100 is transferred to the upper housing 300 via the lower housing 200 by a washing pump. Thereafter, the washing water is again transferred to the washing arm via an upper main flow passage 330 formed in the upper housing 300 by a flow passage control device 500, and is then transferred to a lower washing arm via the lower main flow passage 320.

Some of the washing water is flowed to a discharge pump 110 through a sampling flow passage 310. Thereafter, the washing water via the discharge pump 110 is introduced into the contaminant chamber 210 of the lower housing 200 and is filtered by a filtering part 410 formed in the cover 400. The filtered washing water is again collected in the sump 100.

Unlike the related art dishwasher, the dishwasher according to the above embodiment has the sampling flow passage or channel 310 so as to measure the pollution of the washing water and filter the washing water. Since the washing water via the sampling flow passage 310 is introduced into the contaminant chamber 210 via the discharge pump 110, the pressure applied to the filtering part 410 is lowered due to the washing pump. Accordingly, the filtering part 410 formed in the cover 400 is not easily clogged by contaminant.

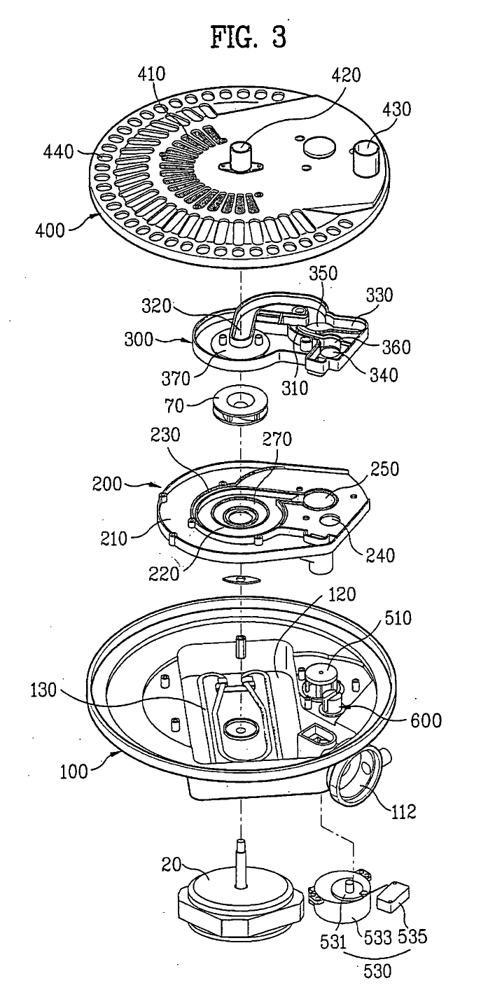

A water collection device for the dishwasher of FIG. 2 will now be described in detail with reference to FIG. 3.

Referring to FIG. 3, the water collection device includes a main motor 20 disposed at a lower side, for providing power, and the sump 100 disposed above the main motor 20 and having a water collection part 120 for collecting washing water.

Inside the sump 100, the lower housing 200 defining the contaminant chamber 210 and the upper housing 300 defining flow passage of washing water are installed. Moreover, the cover 400 for filtering and recollecting washing water is installed above the lower housing 200 and the upper housing 300.

In more detail, the upper housing 300 is inserted into and installed at an upper housing installation part 230 of the lower housing 200. The filtering part 410 formed in the cover 400 is disposed above the contaminant chamber 210 of the lower housing 200.

A heater 130 is installed inside the sump 100. It is preferable that the heater 130 be is submerged in the washing water while the dishwasher operates. The heater 130 heats the washing water up to a proper temperature to facilitate the dishwashing operation.

A valve control device 530 for controlling the main motor 20 and the flow passage control valve is fixed to an outer bottom surface of the sump 100, and the discharge pump (not shown) is fixed to an outer side surface of the sump 100. Preferably, the discharge pump is engaged with a discharge chamber 112.

However, in the present invention, the main motor and the valve control device may be fixed to an outer side surface of the sump, and the discharge pump may be fixed to the outer bottom surface of the sump.

An impeller receiving part 270 for receiving an impeller is formed at a center of the lower housing 200. An inlet flow passage 220 is formed outside the impeller receiving part 270 to allow the washing water transferred by the impeller to be introduced into the flow passage control valve 510. Here, it is preferable that a height difference exists between the impeller receiving part 270 and the inlet flow passage 220.

The contaminant chamber 210 where contaminant contained in the washing water is collected is formed at an outer portion of the inlet flow passage 220. In detail, the upper housing installation part 230 is formed around the inlet flow passage 220 and the contaminant chamber 210 is formed around the upper housing installation part 230. Here, it is preferable that a height difference exists between the inlet flow passage 220 and the housing installation part 230.

Furthermore, the contaminant chamber 210 is formed having a predetermined depth at an outer circumference of the upper housing installation part 230. The contaminant chamber 210 is combined as one with the impeller receiving part 270. Here, the contaminant chamber 210 and the impeller receiving part 270 may be formed separately from each other before being coupled with each other.

Accordingly, the contaminant chamber 210 and the impeller 70 engaged with the impeller receiving part 270 are positioned on a substantially same plane. By doing so, the height of the driving part decreases and the dishwashing space increases.

Meanwhile, the lower housing 200 has a first passing hole 240 through which a pollution sensor 600 for measuring the pollution of washing water passes, and a second passing hole 250, through which the flow passage control valve 50 passes, formed at a connection portion between the inlet flow passage 220 and the upper housing.

The upper housing 300 has an impeller cap 370 for receiving an upper side of the impeller 70, and a second passing hole 350 having the flow passage control valve 510 put through.

Furthermore, the upper housing 300 includes the upper main flow passage 330 for transferring washing water to the upper washing arm, the lower main flow passage 320 for transferring the washing water to the lower washing arm, and the sampling flow passage 310 for transferring the washing water to the discharge chamber 112.

The upper main flow passage 330 and the lower main flow passage 320 are connected with the flow passage control valve 510 installed at the second passing hole 350.

A flow passage extending part 360 where the pollution sensor 600 is installed is formed on the sampling flow passage 310, and a first passing hole 350 through which the pollution sensor 600 passes is formed at a center of the flow passage extending part 360.

The impeller 70 is installed between the upper housing 300 and the lower housing 200 and is axially coupled with the main motor 20. While in the present embodiment, the impeller 70 corresponds to the washing pump for pumping washing water, it is preferable that the washing pump of the present invention includes the impeller.

The impeller 70 is rotated by the main motor 20, and the washing water is introduced into the inlet flow passage 220 from the water collection part 120 of the sump 100 by the rotation of the impeller 70.

The washing water that has passed through the inlet flow passage 220 is distributed to the upper main flow passage 330, the lower main flow passage 320, and the sampling flow passage 310 by the flow passage control device.

The flow passage control device includes the flow passage control valve 510 for controlling direction of the washing water, the valve control device 530 for controlling the flow passage control valve 510, and a packing member (not shown) installed between the flow passage control valve 510 and the valve control device 530.

The flow passage control valve 510 and the packing member are installed inside the sump 100, and the valve control device 530 is installed at an outer lower side of the sump 100.

The cover 400 has the filtering part 410 formed at the center area, for filtering washing water. A plurality of collection holes 440 having a predetermined shape are formed at an outer periphery of the cover 400. The collection holes 440 are provided to collect the washing water filtered by the filtering part 410 to the inside of the sump 100.

Furthermore, the cover 400 has an upper arm coupling part 430 and a lower arm coupling part 420. The upper arm coupling part 430 functions as a passage for the washing water transferred from the upper main flow passage to an upper spray arm. The lower arm coupling part 420 functions as a passage for the washing water transferred from the lower main flow passage to a lower spray arm. The cover 400 may be coupled as one with the upper housing 300 by heat fusion or may be installed separately and coupled by a coupling means.

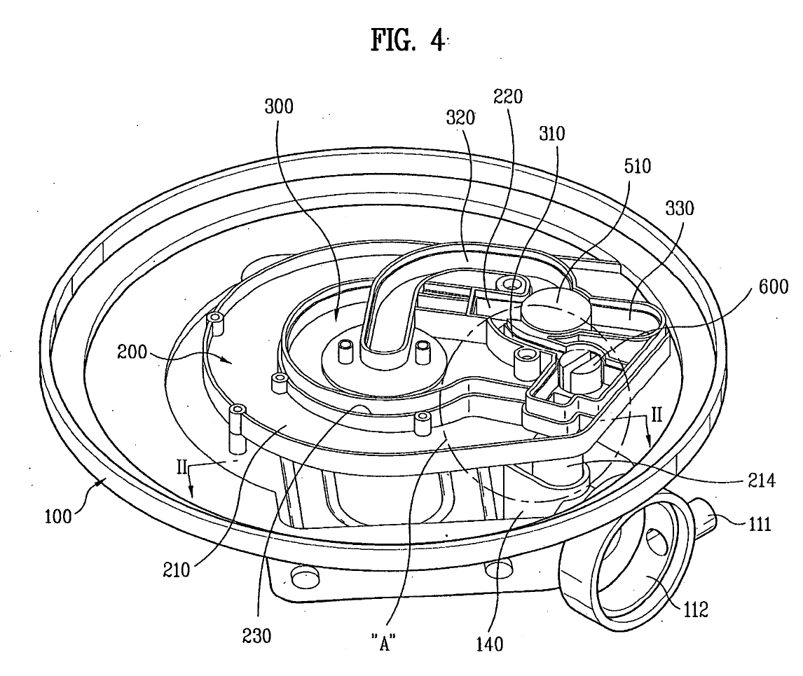

With reference to FIGS. 4-6, a coupling construction of the sump, the upper housing, and the lower housing will now be described.

As mentioned above, the lower housing 200 defining the contaminant chamber 210 is formed inside the sump 100, and the upper housing 300 is inserted into and installed at the upper housing installation part 230 of the lower housing 200.

The upper housing 300 includes the upper main flow passage 330, the lower main flow passage 320, and the sampling flow passage 310. The pollution sensor 600 for measuring the pollution of the washing water is installed on the sampling flow passage 310.

The pollution sensor 600 has a light emitting element for emitting beams onto the washing water, and a light receiving element for receiving the emitted beams. A flow passage is formed between the light emitting element and the light receiving element. The pollution sensor 600 measures the pollution of the washing water using an interaction of the beams received by the light receiving element.

The sampling flow passage 310 functions to connect the inlet flow passage 220 formed at the lower housing with the discharge chamber 112 having the discharge pump. In more detail, one end of the sampling flow passage 310 is connected with the inlet flow passage 220 for introducing the washing water into the upper housing 300, and the other end of the sampling flow passage 310 is connected to a coupling part 214 for guiding the washing water to the discharge chamber 112.

The coupling part 214 is protruded in a downward direction of the lower housing 200 at a point where the sampling flow passage 310 is connected to the discharge chamber 112. More specifically, the coupling part 214 is protruded in a downward vertical direction from the lower housing 200.

In addition, the coupling part 214 is inserted into a connection tube connected with the discharge chamber 112. A discharge pipe 111 for discharging washing water is also connected to the discharge chamber 112.

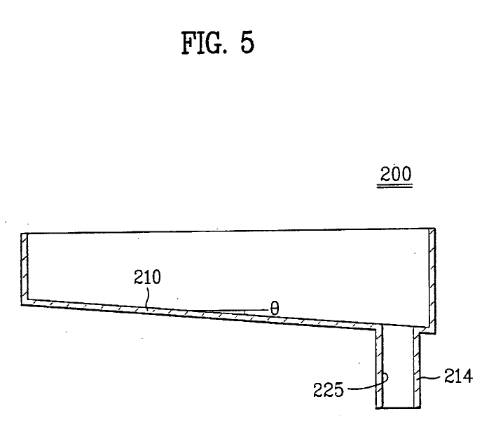

As shown in FIG. 5, a bottom of the contaminant chamber 210 is inclined at a predetermined angle (0) in an opposite direction of the discharge chamber 112 to which the washing water is discharged. More specifically, the bottom of the contaminant chamber 210 is declined toward the discharge pump, which is to discharge contaminant collected in the contaminant chamber during the discharge cycle.

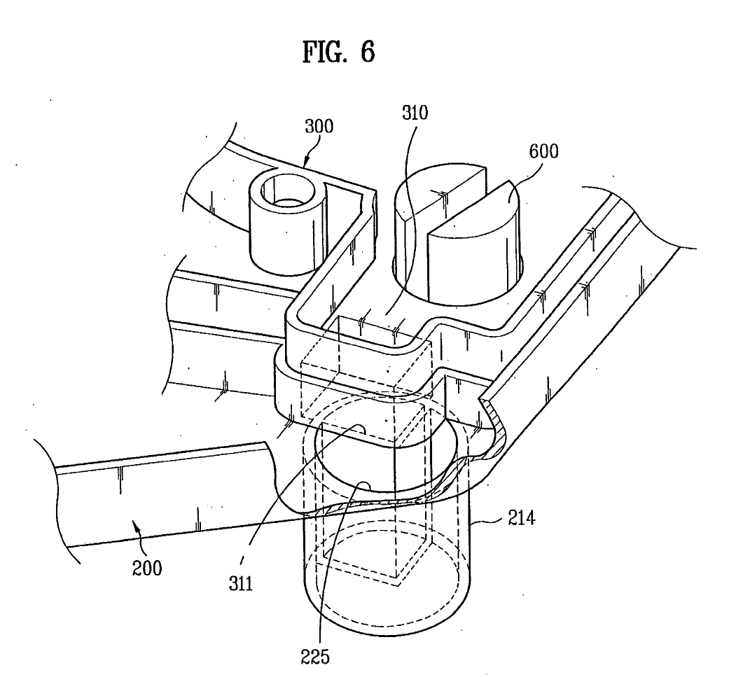

A flow of the washing water via the sampling flow passage is introduced into the discharge pump will now be described with reference to FIG. 6.

The sampling flow passage 310 through which some of the washing water flows is formed at the upper housing 300, and a sampling flow passage discharge part 311 through which the washing water via the sampling flow passage is discharged is formed at one end of the sampling flow passage 310.

The lower housing has the coupling part 214 connected with the sampling flow passage discharge part 311. A first connection flow passage 225 through which the washing water via the sampling flow passage flows to the discharge pump is formed inside the coupling part 214.

In other words, while the dishwasher performs a washing cycle, washing water continuously flows through the sampling flow passage, and the washing water discharged from the sampling flow passage 310 flows to the discharge pump via the first connection flow passage 225.

However, since the discharge pump does not operate during the washing cycle, the washing water is not discharged. Accordingly, the washing water via the discharge pump is transferred to the contaminant chamber through a second connection flow passage (not shown).

A flow of washing water during operation of the dishwasher of the present invention will now be described with reference to FIGS. 3, 7 and 8.

As the washing cycle of the dishwasher begins operation, the main motor 20 operates, making the impeller 70 rotate. As the impeller 70 rotates, the washing water received in the water collection part 120 is introduced into the inlet flow passage 220 of the lower housing 200.

The washing water via the inlet flow passage 220 is introduced into the upper main flow passage 330 or the lower main flow passage 320 by the flow passage control valve 510 for controlling the direction of the washing water. In other words, the flow passage control valve 510 opens and closes the upper main flow passage 330 and the lower main flow passage at the same time, selectively or alternatively.

At this time, some of the washing water via the inlet flow passage 220 is introduced into the sampling flow passage 3 Id of the upper housing 300. In other words, washing water always flows through the sampling flow passage 310 regardless of the direction of the washing water controlled by the flow passage control valve 510.

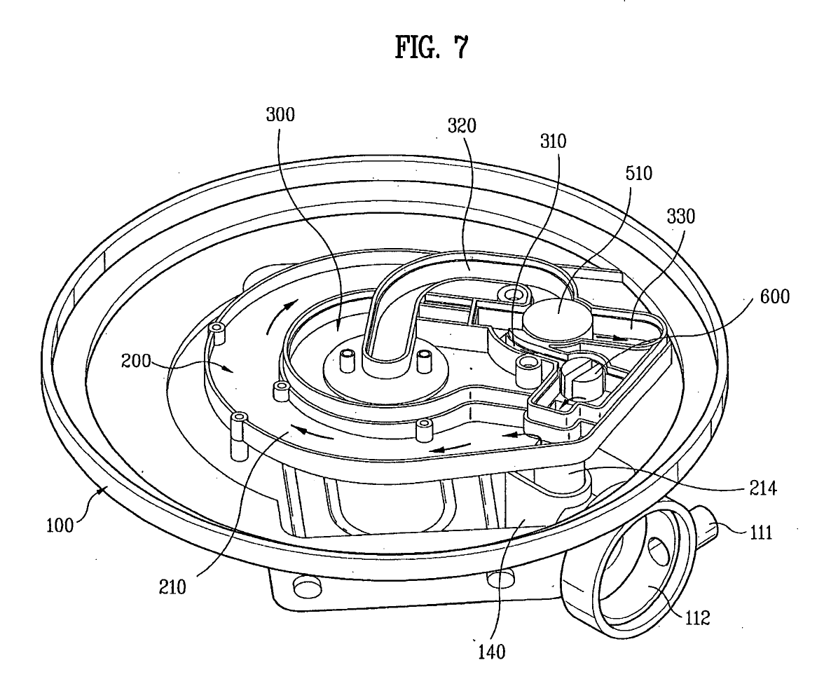

When the washing water is introduced into the upper spray arm as shown in FIG. 7, the washing water is introduced into the upper main flow passage 330 by the flow passage control valve 510 but does not flow through the lower main flow passage 320. In addition, some of the washing water is introduced into the sampling flow passage 310.

The washing water introduced into the sampling flow passage 310 is introduced into the discharge chamber 112 through the first connection flow passage (not shown) formed inside the coupling part 214. At this time, contaminant having a heavy weight in the garbage mixed with the washing water settles at a bottom of the discharge chamber 112. In other words, the discharge chamber 112 provides a place where the contaminant is dropped to the bottom during the washing cycle.

The washing water introduced into the discharge chamber 112 is introduced into the contaminant chamber 210 through the second connection flow passage (not shown) formed at the coupling part 214. At this time, a relatively small garbage is introduced into the contaminant chamber 210 and an introduction amount of the garbage decreases. This is because heavy garbage is not easily introduced into the contaminant chamber 210 positioned higher than the discharge chamber 112 due to its selfweight.

Accordingly, a clogging time of the filtering part 410 of the cover positioned at the upper side of the contaminant extends and a less water pressure is applied to the contaminant chamber 210.

Of course, it is possible to filter the washing water before the washing water of the discharge chamber 112 is introduced into the contaminant chamber 112 via the second connection flow passage, by installing a filter having a mesh inside the discharge chamber 112.

The washing water introduced into the contaminant chamber 210 overflows through the filtering part 410 formed at the cover. At this time, the filtering part 410 secondarily filters the washing water to get rid of small garbage or contaminants.

Thereafter, the filtered washing water is again introduced into the sump 100 through the collection holes 440 of the cover 400. Herein, the pumping force of the impeller 70 serves as an original force that allows washing water to be introduced into the contaminant chamber 210 via the discharge chamber 112.

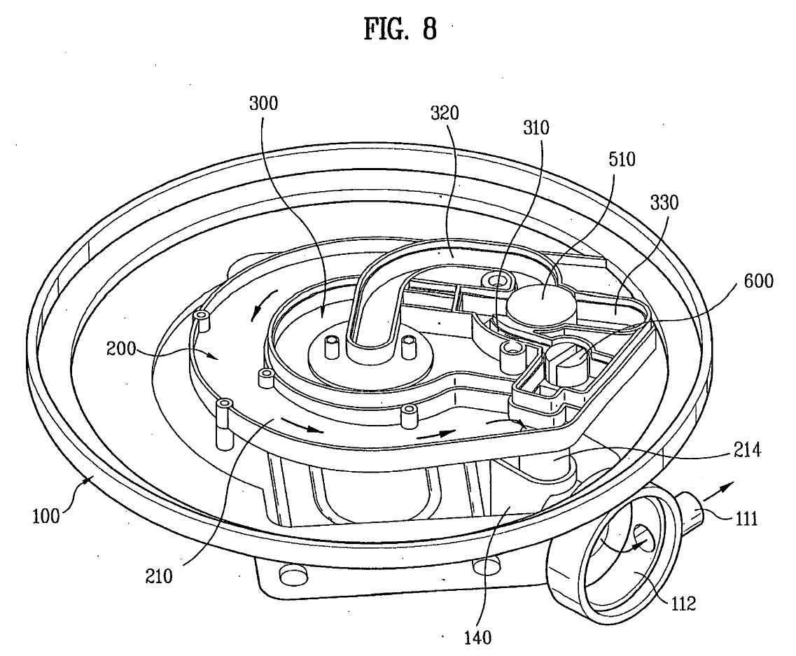

After the washing cycle is completed, discharge cycle starts as shown in FIG. 8.

As the discharge cycle starts, the discharge pump installed at the discharge chamber 112 begins operation. Then, the washing water of the sump 100 and the garbage are introduced into the discharge chamber 112 by a suction force of the discharge pump. In other words, the washing water and the garbage remaining in the sump 100 are introduced into the discharge chamber 112 via the discharge holes (not shown).

Furthermore, the washing water and the garbage of the contaminant chamber 210 are introduced into the discharge chamber 112. Here, since the garbage is smoothly discharged along the inclined bottom surface of the contaminant chamber 210, most of the garbage does not remain in the contaminant chamber 210. After that, the washing water and the garbage introduced into the discharge chamber 112 are discharged through the discharge pipe 111 to the outside.

As described above, the dishwasher according to the present invention has the following effects. First, since the impeller and the contaminant chamber are positioned on the substantially same plane, the height of the driving part of the dishwasher can decrease, thereby increasing the dishwashing space relative to in the related art dishwasher.

Second, since the bottom surface of the contaminant chamber is inclined toward a direction in which washing water is discharged, the contaminant collected in the contaminant chamber is easily discharged.

Third, since the washing water pumped in the sump is introduced into the contaminant chamber via the discharge chamber, a large volume of garbage is sunk to the bottom. Accordingly, only the large volume of garbage is introduced into the contaminant chamber and introduction amount of the garbage is remarkably decreased, thereby minimizing the filtering part of the cover from being clogged.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A dishwasher, comprising:
a sump for collecting washing water for washing a contaminated dish;
a main motor for circulating the washing water collected in the sump;
a washing pump having an impeller connected with the main motor to pump the washing water;
a discharge pump disposed at a predetermined portion of the sump for discharging the washing water; and
a lower housing having a contaminant chamber disposed on a substantially same plane as the impeller for filtering contaminants from the washing water.

2. The dishwasher of claim 1, wherein the lower housing comprises an impeller receiving part for receiving a lower portion of the impeller.

3. The dishwasher of claim 2, wherein the impeller receiving part comprises an inlet flow passage, and through which the washing water collected in the sump is introduced, formed around the receiving part, the inlet flow passage has a height difference with the impeller receiving part.

4. The dishwasher of claim 3, further comprising an upper housing having an impeller cap for receiving an upper side of the impeller.

5. The dishwasher of claim 4, wherein the upper housing comprises a sampling flow passage connecting the inlet flow passage with the discharge pump.

6. The dishwasher of claim 5, wherein the washing water introduced into the inlet flow passage during a washing cycle is introduced into the contaminant chamber sequentially via the sampling flow passage and the discharge pump.

7. The dishwasher of claim 3, wherein an upper housing installation part on which the upper housing is installed is formed around the inlet flow passage with a predetermined height difference from the inlet flow passage.

8. The dishwasher of claim 7, wherein the contaminant chamber is formed around the upper housing installation part with a predetermined depth.

9. The dishwasher of claim 8, wherein the impeller receiving part and the contaminant chamber are formed as an integrated member.

10. The dishwasher of claim 8, wherein the contaminant chamber has an angled bottom surface declining in a direction of the discharge pump.

11. The dishwasher of claim 4, further comprising a cover having a filtering part for filtering the washing water introduced into the contaminant chamber.

12. The dishwasher of claim 11, wherein the cover is installed at an upper side of the upper housing and the lower housing.

13. The dishwasher of claim 1, wherein the lower housing comprises a contaminant chamber having a bottom surface declining at a predetermined angle in a direction of a discharge chamber.

14. A dishwasher, comprising:
a sump for collecting washing water for washing a contaminated dish;
a main motor for circulating the washing water collected in the sump;
a washing pump having an impeller connected with the main motor to pump the washing water;
a discharge pump disposed at a predetermined portion of the sump for discharging the washing water; and
a contaminant chamber has the washing water pumped by the impeller is continuously introduced and has an angled bottom surface declining at a predetermined angle.

15. A dishwasher of claim 14, wherein a bottom surface of the contaminant chamber is declining at the predetermined angle in a direction of a discharge chamber.
